(19) United States
(12) Patent Application Publication
(10) Pub. No.: US 2018/0092387 A1
(43) Pub. Date: Apr. 5, 2018

(54) MEANS AND METHOD FOR SALT ROASTING OF FOOD

(71) Applicant: Gido FOSCHNEANO, Rishon Le Zion (IL)

(72) Inventor: Gido FOSCHNEANO, Rishon Le Zion (IL)

(21) Appl. No.: 15/563,648

(22) PCT Filed: Mar. 31, 2016
(86) PCT No.: PCT/IL16/50356

§ 371 Date: Oct. 2, 2017

Related U.S. Application Data
(60) Provisional application No. 62/142,486, filed on Apr. 3, 2015.

(51) Int. Cl. A23L 5/10

(52) U.S. Cl. CPC A23L 5/10

(57) ABSTRACT

A salt roasting means for roasting foodstuff in a hot closed space with central space for placing the foodstuff and peripheral location or locations surrounding the central space. The peripheral location or locations are configured to accommodate sufficient amount of salt for generating thermal barrier around and above the central space and foodstuff without having direct physical contact with the foodstuff. The thermal barrier blocks hot vapors coming out of the foodstuff from diffusing away.

### TECHNICAL FIELD

The present invention pertains to roasting of food. More particularly, the present invention pertains to roasting of food in the presence of salt.

### BACKGROUND

Roasting is a cooking method that uses dry-heat where hot air envelops the food, cooking it evenly on all sides with temperatures of at least 150° C. from an open flame, oven, or other heat source. Roasting can enhance flavor through caramelization and Maillard browning (basically, the combination of sugars with proteins) on the surface of the food. Roasting uses indirect, diffused heat (as in an oven), and is suitable for slower cooking of meat in a larger, whole piece. Meats and most root and bulb vegetables can be roasted. The resulting roasted food is tender, especially meat.

As meat roasts, the structure and especially the collagen breaks down, allowing juice to come out of the meat. So meat is juiciest at about medium rare while the juice is coming out. During roasting, meats and vegetables are frequently basted on the surface with butter, lard, or oil to reduce the loss of moisture by evaporation. In recent times, plastic oven bags have become popular for roasts. These cut cooking times and reduce the loss of moisture during roasting, but also reduce flavor development from Maillard browning, somewhat more like (boiled or steamed) stew or pot roast. They are particularly popular for turkeys.

During oven roasting, hot air circulates around the meat, cooking all sides evenly. There are several plans for roasting meat: low-temperature cooking, high-temperature cooking, and a combination of both. Each method can be suitable, depending on the food and the tastes of the people. A low-temperature oven, 95° C. to 160° C. (200° F. to 325° F.), is best for slow roasting of large cuts of meat, turkey and whole chickens, resulting in less moisture loss and a more tender product. More of the collagen that makes meat tough is dissolved in slow roasting. At true roasting temperatures, 200° C. (400° F.) or more, the water inside the muscle is lost at a high rate. Cooking at high temperatures is beneficial for finished cooking that browns the outside of the food before the juices escape. Fast cooking gives more variety of flavor, because the outside is brown while the center is much less done.

Salt roasting is a cooking technique for maintaining the moisture in the food without any supplemental ingredients. This is achieved by covering a large cut of meat, chicken, fish, and any other large piece of meat or even vegetables and fruits with a thick layer of salt and baking it. The salt encrusts around the meat forming a tight seal around the meat that bakes inside the salt shield. All of the flavor and juices get trapped in the salt shell to create a cooking environment that is part roasting and part steaming. See http://www.dartagnan.com/Salt-Roasting-Basics/SaltRoastingBasics,default,pg.html

While current salt roasting provides good results, it wastes significant amounts of salt and requires some labor in preparing the salt shell before roasting, breaking it afterwards to get to the cooked food and removing crusted salt crumbs. Additionally, gluing additives as egg whites are needed to form the salt crust, resulting in further waste of material and work in addition to making the salt batch unsuitable for further use.

It is, therefore, an object of the present invention to provide means and method for salt roasting that overcome the disadvantages of current salt roasting technique while maintaining its benefits.

It is yet another object of the present invention to provide means and method for salt roasting that is much less time, work and ingredient consuming.

It is yet another object of the present invention to provide means and method for multiple-use of single salt batch in salt roasting.

It is yet another object of the present invention to provide means and method for salt roasting without physical contact between the salt used and roasted foodstuff.

It is yet another object of the present invention to provide means and method for salt roasting that is expandable to large scale roasting.

This and other objects and embodiments of the present invention shall become apparent as the description proceeds.

### SUMMARY

In one aspect, the present invention provides salt roasting means for roasting foodstuff in a hot closed space, where such means comprises central space for placing the foodstuff and peripheral location or locations that surround the central space. Particularly, the peripheral location or locations are configured for distributing salt around the foodstuff, where the configuration of the peripheral location or locations relative the central space enables the salt to generate thermal barrier around and above the central space and foodstuff. Such thermal barrier blocks hot vapors coming out of the foodstuff from diffusing away without having direct physical contact with the foodstuff.

In one particular non-limiting embodiment, the salt roasting means is a cooking vessel that comprises central space for placing foodstuff on it and at least one cavity surrounding the central space and which is configured to accommodate salt in a configuration that enables the salt to generate thermal barrier around the central space and foodstuff placed on it without direct physical contact with the foodstuff. In one particular configuration, the cavity may be a closed channel that surrounds the central space of the cooking vessel having depth, height and width sufficient to accommodate an amount of salt sufficient to generate the thermal barrier around and over the central space and foodstuff. In another particular configuration, the peripheral locations may be a plurality of cavities separate from each other and surrounding the central space and foodstuff. These cavities have depth, height and width sufficient to accommodate an amount of salt, which is sufficient to generate the thermal barrier around and above the central space and foodstuff. Furthermore, the cavities are of such dimensions and number that enable them to operate in concert in generating the desired thermal barrier when accommodating sufficient amount of salt.

In still another particular non-limiting embodiment, the geometric shape of the cooking vessel is selected from round, triangular, rectangular, pentagonal, hexagonal and octagonal shaped tray. Further, the cooking vessel may be of any depth for providing sufficient volume for containing the foodstuff.

In still another particular non-limiting embodiment, the foodstuff suitable for salt roasting with the means and method of the present invention is selected from meat such as, chicken, fish, cattle meat, turkey, vegetables such as potatoes and onions and fruits.

The salt roasting vessel may provide closed volume for smoking the foodstuff. Particularly, the salt roasting vessel may comprise a cover, particularly glass made or Pyrex made cover with opening for introducing liquids onto the foodstuff during the smoking process. Further, the salt in the surrounding channel around the central area of the vessel may further comprise flavor enhancing additives for smoking the foodstuff. Examples of such additives may any combination of Hickory wood chips and different types of herbs, e.g., Rosemary.

In still another aspect, the present invention provides closed space heat generating means configured for accommodating the salt roasting means and provide appropriate thermal conditions for salt roasting foodstuff placed on a central space of the salt roasting means with salt distributed on peripheral location or locations surrounding the central space and foodstuff.

The salt roasting means that accommodates the foodstuff and salt may be made of any material that is a good heat conductor. Particularly, such material may be selected from metals, metallic alloys and ceramics. Particularly, galvanized iron, metallic alloys containing copper, nickel, chromium, molybdenum and carbon, aluminium, cast iron, carbon steel, stainless steel, austenitic stainless steel, enameled cast iron, enamel over steel, clad aluminium or copper, glazed ceramics and porcelain, may be used for a tray for salt roasting according to the present invention. However, less efficiently heat conducting materials are also contemplated within the scope of the present invention, since the salt and foodstuff absorb heat also from the surrounding hot air in the closed space heat generating means. Therefore, materials such as tempered glass, borosilicate glass, glass-ceramic and baking stone are also contemplated within the scope of the present invention.

Still in a particular embodiment, the salt roasting means may comprise non-stick coating on the inner surface. Such non-stick coating is engineered to reduce the ability of other materials to stick to it and allows foodstuff to brown without sticking to the surface. Non-stick Non-stick coating for the inner surface of the salt roasting means may be selected from any one of polytetrafluoroethylene (PTFE), anodized aluminium, ceramics, silicone, enameled cast iron, black stone or marble stone and seasoned cast iron.

Particularly, the marble stone may be made by combining different coating particles tightly together to provide scratch-free and hardened surface. The marble stone coating may also be provided by liquefying the stone and casting it on the inner surface of the salt roasting means. The thickness of the marble stone or black stone may be any one between 25 to 60 μm.

The non-stick coating detailed above renders the salt roasting means versatile for cooking in an oven as well as on open fire and stove.

Further, the outer lower surface of the salt roasting means may also comprise an induction ferrous layer for induction cooking. As a result, the salt roasting means may further be versatile to allow the cooking of foodstuff using heat induction.

In one particular embodiment, the salt used for salt roasting in the present invention is sodium chloride (NaCl) due to its high melting temperature, 801° C., good heat conductivity 4.85 W/meter^{•}° C. at 127° C. and relative low toxicity to human body. The type and origin of the sodium chloride may vary. Kosher salt that has relatively large crystals, table salt with more refined crystals and Atlantic sea salt are all contemplated within the scope of the present invention.

In particular non-limiting embodiment the closed space heat generating means is an oven. Particularly, the oven may be selected from any type of oven that provides appropriate physical and thermal conditions for the distributed salt to generate the thermal barrier around and above the central space and foodstuff and enable salt roasting to take place without physical contact between the surrounding salt and foodstuff. Particular non-limiting examples of suitable types of ovens are ceramic oven, brick oven, gas oven, electric oven, masonry oven and wall oven.

In still another aspect, the present invention provides a method for salt roasting foodstuff, where the method comprises:

providing salt roasting means comprising central space configured for placing foodstuff and peripheral location or locations that surround the central space for placing the foodstuff and configured for distributing salt around the foodstuff;
providing closed space heat generating means;
elevating the temperature in the closed space heat generating means;
distributing batch of salt in the peripheral location or locations of the salt roasting means;
providing foodstuff and placing it on the central place of the salt roasting means;
placing the salt roasting means with the foodstuff and distributed salt in the closed space heat generating means;
roasting the foodstuff for a desired period of time;
taking the salt roasting means out of the closed space heat generating means;
removing the foodstuff that is roasted; and
removing the distributed salt.

The salt roasting method detailed above may further comprise:

removing disposable residues of the foodstuff after salt roasting off of the salt roasting means;
cleaning the salt roasting means;
placing another foodstuff on the central space of the salt roasting means;
distributing the batch of salt in the peripheral location or locations of the salt roasting means; and
reiterating the salt roasting method as detailed above.

The following will describe particular and non-limiting examples of the present invention with reference to the drawings without departing from the scope and spirit of the present invention.

### BRIEF DESCRIPTION OF THE DRAWINGS

FIG. 1 exemplifies currently used salt roasting technique.

FIGS. 2A-2C illustrate and display salt roasting means according to the present invention.

FIG. 3A-3B illustrate salt roasting means according to the present invention.

FIG. 4 illustrate another configuration of salt roasting means according to the present invention.

FIG. 5 illustrates basic physical principles of salt roasting according the present invention.

FIGS. 6A-6D display application of salt roasting according to the present invention.

FIGS. 7A-C illustrate perspective, top and cross-section views of a cooking vessel with installed inner channel for accommodating the salt.

### DETAILED DESCRIPTION OF THE DRAWINGS

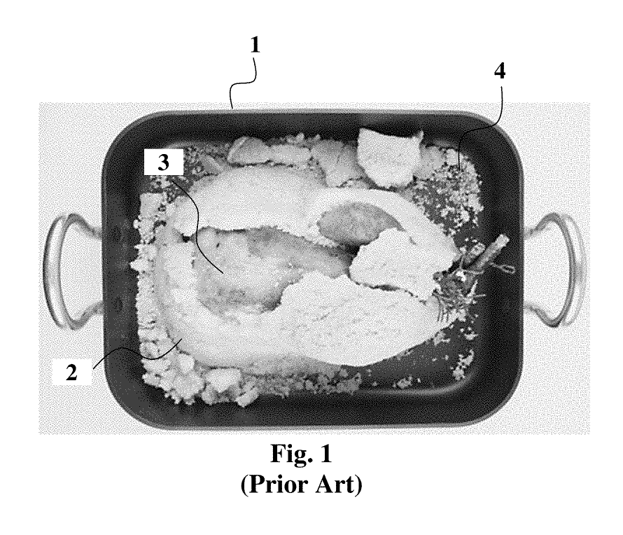

Conventional, currently used salt roasting requires that the cooked foodstuff be entirely covered with salt shield. FIG. 1 exemplifies such salt roasting, where a whole chicken (3) is placed in a metal tray (1) and covered with a salt shell (2) made of large amount of relatively large salt crystals, also known as kosher salt. The crystals of the salt shell (3) are usually glued together with egg white or any other edible gluing material. When the tray (1) is placed in a hot oven, for example, the fluids within the chicken boil but cannot escape out of the salt shell. In this respect, the salt shell fulfills two functions: retaining even and constant heat within the chicken (3) and preventing the fluids from escaping. The chicken (3) or any other foodstuff for that matter is actually cooked in its own juices, resulting in a tender meat that preserves the original flavors. However, as is obvious from the picture in FIG. 1, the salt shell (2) should be broken and removed to get to the foodstuff, which results in unwanted salt crumbs (4), which also causes further work and might also remain on the cooked food, e.g., chicken (3), damaging its taste. Furthermore, some of the salt of the salt shell (2) might be absorbed within the food during roasting, which counteracts the purpose of salt roasting resulting in unwanted salting of the food and damage to its original flavor.

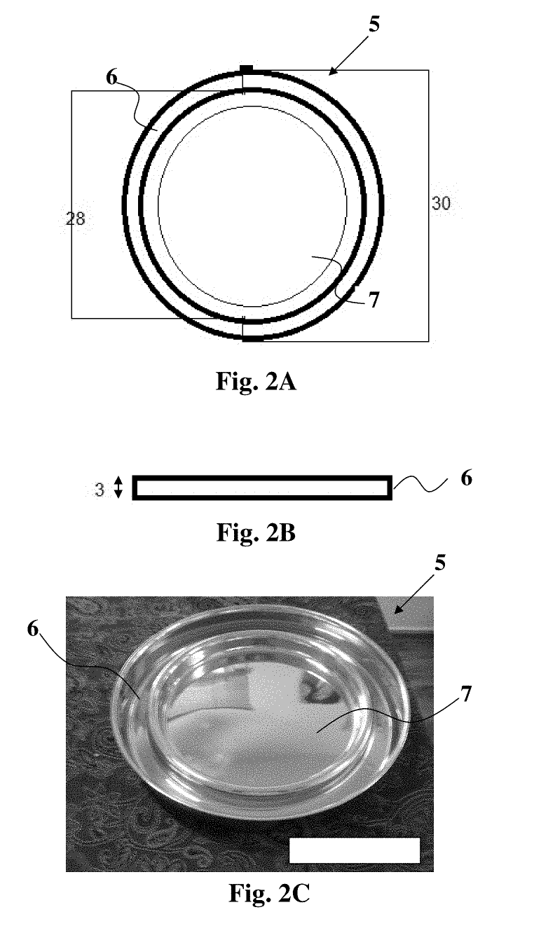

These shortcomings of current salt roasting are overcome by the means and methods of the present invention. FIGS. 2A-2C illustrate and display particular non-limiting configuration of means for salt roasting according to the present invention. FIG. 2A illustrates top view of a round-shaped tray (5) that has central round space (7) sufficiently large to place foodstuff from large cuts of meat to significant amount of vegetables, fruits and the like. A peripheral channel (6) surrounds the central round space (7) at the margins of the tray (5). The surrounding channel (6) has a certain depth, as shown in the cross section in FIG. 2B that is sufficient for safely accommodating an amount of salt that is sufficient for obtaining salt roasting of foodstuff according to the present invention. FIG. 2C displays actual metallic, in this case austenitic stainless steel, round-shaped salt roasting tray (5) of the present invention. However, the use of metallic materials for salt roasting is not obligatory and other materials suitable for this purpose may be used.

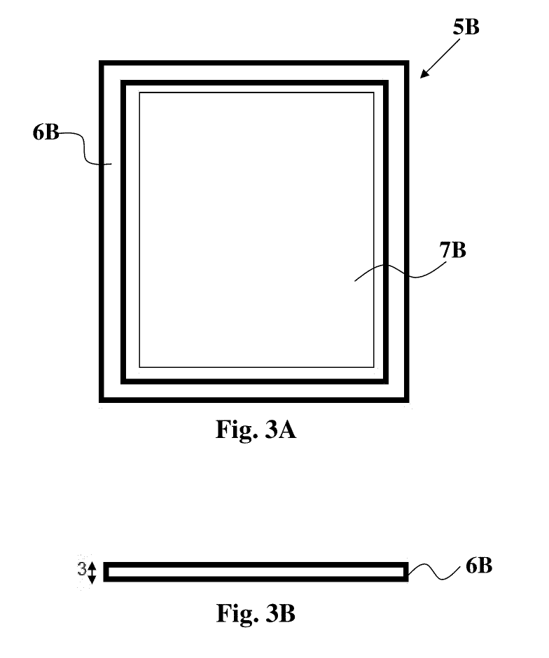

FIGS. 3A-3B demonstrate that the geometric structure of the salt roasting tray of the present invention is not significant for salt roasting according to the present invention as long as it enables surrounding foodstuff to be roasted with salt. In the example in FIGS. 3A-3B rectangle shaped tray (5B) having rectangular central space (7B) and peripheral channel (6B) having certain depth as shown in FIG. 2B, comfortably meets such requirement. Foodstuff, particularly large cuts of meat, may be placed in the rectangular central space (5B) of the tray, while sufficient amount of salt crystals surrounds it when distributed in the peripheral channel (6B).

Without limiting to a particular physical model, it is assumed that the physical principles of salt roasting are as discussed in relation to FIG. 5 and are the same for any geometrical shape of the salt roasting means according to the present invention. These principles are detailed as follows: Foodstuff (3), for example cut of meat, chicken or fish, is placed in the central space (7) of the tray (5). Sufficient amount of salt (8) is distributed in the peripheral locations (6), e.g. peripheral channel, around the central space (7), in which the foodstuff (3) is placed. The tray (5) is placed in an oven, which is heated to any desired temperature. The tray (5) and air within the oven heats up, causing the foodstuff (3) and salt (8) in peripheral location (6) to be heated as well. The heating of the foodstuff (3) causes the fluids (10) it contains to reach their evaporation point and expel out of it. Normally, fluids (10) leaving foodstuff (3) in a heating process, diffuse away towards colder, lower temperature regions, and eventually leave the foodstuff (3) dry. The covering of foodstuff (3) with salt intended to avoid this is now replaced with surrounding the foodstuff with salt (8) without physical contact between them. With above 800° C. melting point, salt is a good heat absorber and emitter and in the present invention it operates as heat generator. Heat induction takes place, when the salt (8) absorbs heat from the heated tray (5) and emits it back to the surrounding air in the oven as schematically illustrated in FIG. 5. Such absorption and emission of heat by the salt generates constant cover of hot air (9) around the foodstuff (3) and particularly the vapors (10) expelled out of it. The cover of hot air (9) generated by the salt (8) creates thermal barrier that does not allow the hot vapors (10) that reach it to migrate to colder, lower temperature regions within or outside the oven. The hot air of the cover (10) actually prevents local temperature difference between the foodstuff (3) and hot vapors (10) to their surroundings and as a result the diffusion of the hot vapors (10) away from the foodstuff (3). Instead the hot vapors (10) are forced to condense, drop back, liquefy on the foodstuff (3) and the central space (7) of the tray (5) and evaporate again in a repeating cycle, covering the foodstuff (3) with humid blanket in which it cooks until a desired texture is achieved or for selected period of time.

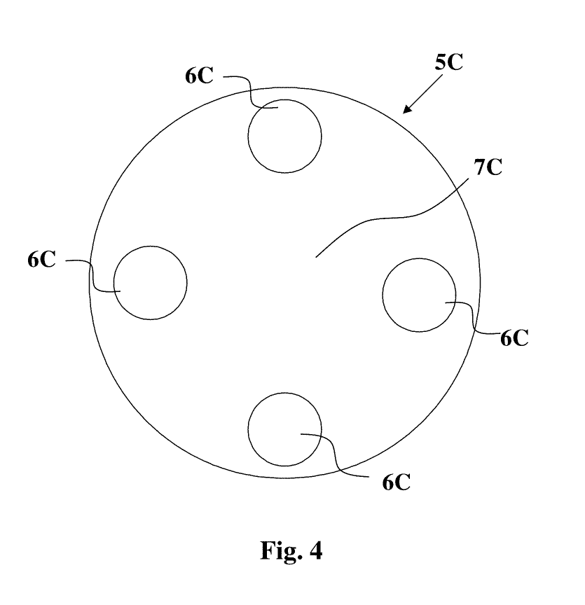

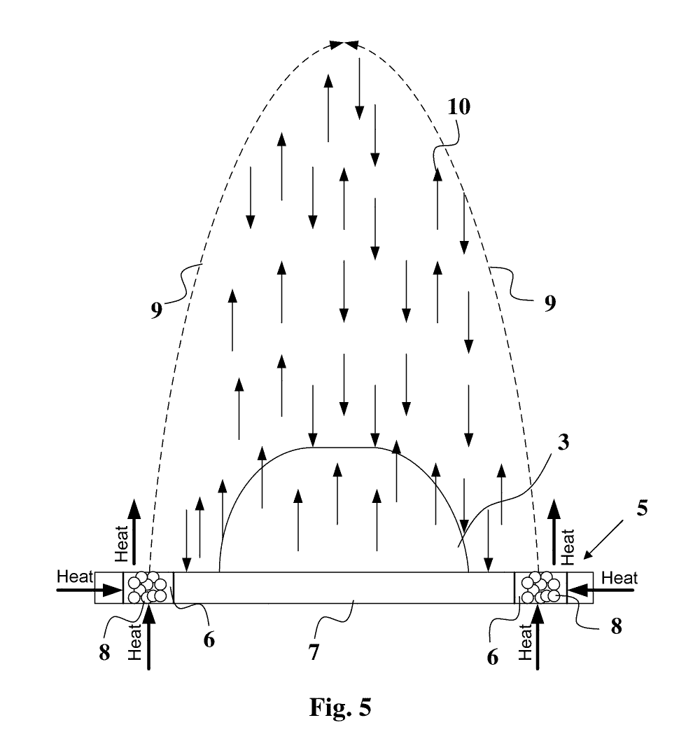

The distribution of salt around the central space in the tray may be done in any configuration that generates the cover of hot air around and over the foodstuff and humid blanket around it. FIG. 4 illustrates top view of another non-limiting configuration of a tray (5C) of the present invention. The central space (7C) for placing foodstuff is surrounded by circular cavities (6C) that are sufficiently large for accommodating salt amounts that generate the hot air cover over the foodstuff and vapors rising out of it and liquefying back on it and on the central space (7C) of the tray. The radiation of heat from the salt in any two neighbor cavities to the surrounding air overlap, thereby forming a unified cover of hot air from the surface of the tray (5C) up and above the foodstuff and hot vapors. In this configuration as well, the hot air cover serves as thermal barrier that prevents the hot vapors to diffuse away from the foodstuff towards lower temperature regions in or outside an oven, in which the tray (5C) is placed.

In fact, any configuration that generates thermal barrier that surrounds the foodstuff and hot vapors is contemplated within the scope of the present invention. Therefore, any configuration of tray that accommodates foodstuff in a central space and salt surrounding it in the periphery of the tray provides proper geometric that generates the physical conditions for salt roasting according to the present invention.

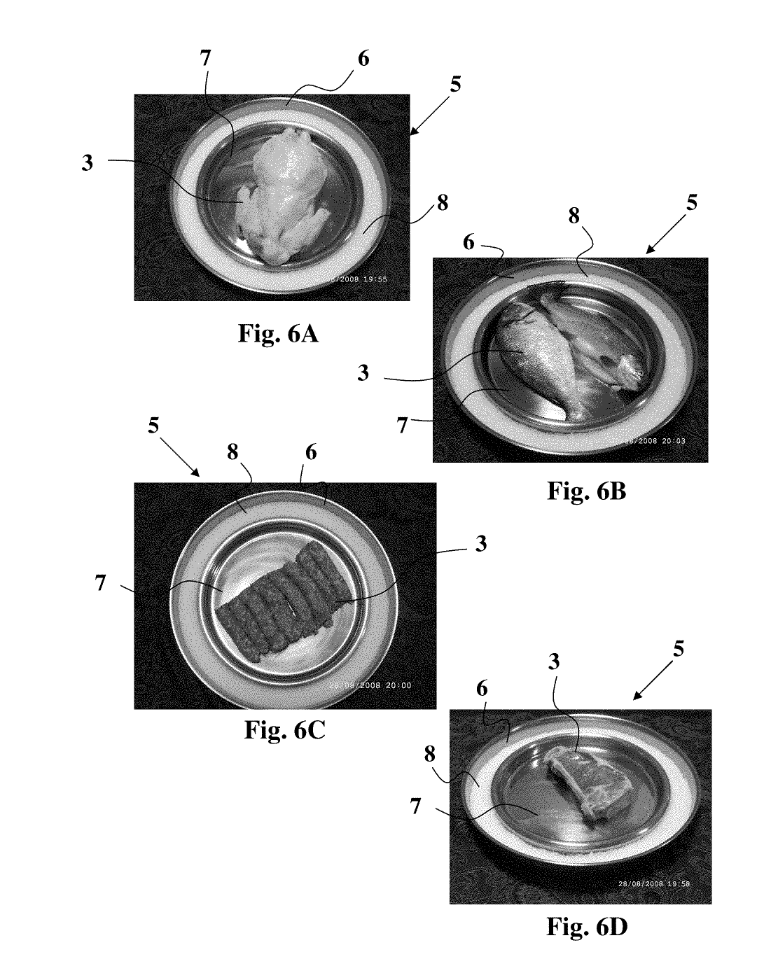

FIGS. 6A-6D display particular uses of a round-shaped tray (5) of the present invention for salt roasting of different types of meat. Chicken, fish, meat roles and meat cut (3) are placed on the central space (7) that is sufficiently large to accommodate even large or a large number of foodstuff. Salt (8), preferably kosher salt having relatively large salt crystals, is distributed on a closed round channel (6) that surrounds the central space (7) and meat foodstuff (3) on it. Placing the tray (5) in a hot closed space, such as an oven, provides proper conditions for the salt (8) to generate the thermal barrier in the form of hot air cover around and above the central space (7) and meat (3). The thermal barrier formed by the heat absorbing and emitting salt (8) provides better and at least equally efficient substitute for the salt mask, which is used in current salt roasting methods (see FIG. 1). Furthermore, the lack of physical contact between the foodstuff (3) and salt (8) leaves the latter clean from any fluids coming out of the roasted foodstuff and allows multiple re-use of the salt (8) for as many salt roasting cycles as desired.

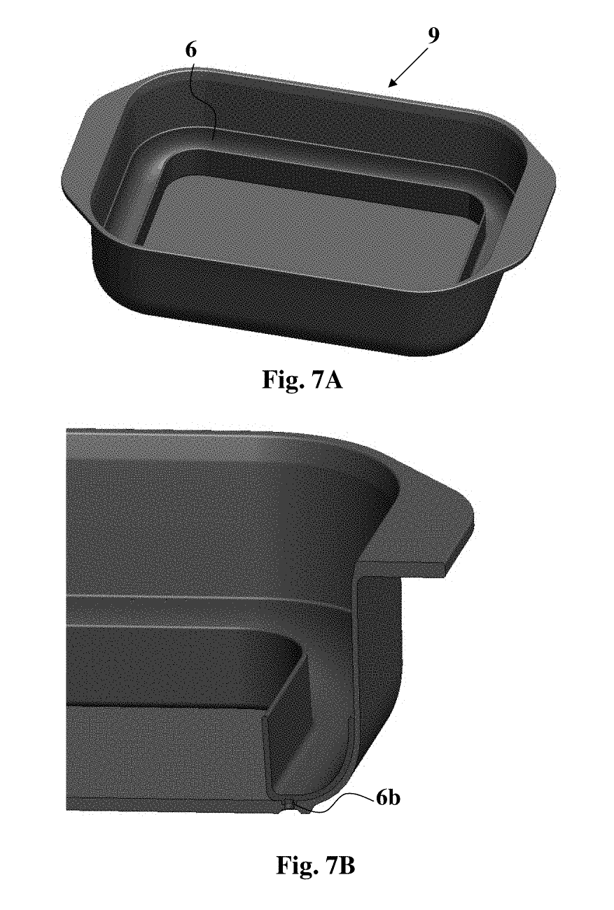

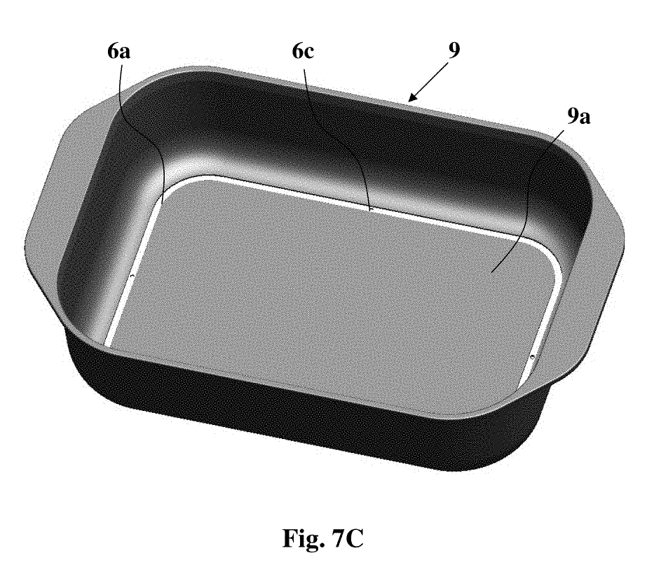

Salt roasting of foodstuff may also be done in cookware that does not include a channel for accommodating the salt. Such cookware is converted to salt roasting according to the present invention by installing a removable closed channel around the inner perimeter for containing the salt. FIGS. 7A-C illustrate perspective, top and cross-section views of a cooking vessel (9) in which an inner channel (6) has been installed for accommodating the salt. The inner channel (6) may be either permanently or temporarily installed within the vessel (9). FIG. 7C shows the recess (6a) at the bottom surface (9a) of the vessel (9) for receiving the installed channel (6). The recess (6a) is engraved in the bottom surface (9a) around the inner perimeter of the vessel (9) and matches rail (6b) that extends out of the bottom of the channel (6). The rail (6b) locks within the recess (6a) for holding the channel (6) in place. Holes (6c) may be drilled within the recess (6a) for further securing, locking or fastening the channel (6) to the bottom surface of the vessel (9) with screws. At the end of cooking, the channel (6) may be removed out of the vessel (9), which then may be used for ordinary cooking.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A salt roasting means for roasting foodstuff in a hot closed space, wherein said means comprises central space for placing said foodstuff and peripheral location or locations surrounding said central space, said peripheral location or locations are configured for accommodating sufficient amount of salt for generating thermal barrier around and above said central space and foodstuff without having direct physical contact with said foodstuff, wherein said thermal barrier blocks hot vapors coming out of said foodstuff from diffusing away.

2. The salt roasting means according to claim 1, wherein said means is a cooking vessel comprising central space for placing foodstuff on it and at least one cavity surrounding said central space, said at least cavity is configured to accommodate salt in a configuration that enables said salt to generate thermal barrier around said central space and foodstuff placed on it without direct physical contact with said foodstuff.

3. The salt roasting means according to claim 2, wherein said cooking vessel is a tray, said at least one cavity is a closed channel surrounding said central space, said close channel having depth, height and width sufficient to accommodate an amount of salt sufficient to generate said thermal barrier around and over said central space and foodstuff.

4. The salt roasting means according to claim 1, wherein said peripheral locations are a plurality of cavities separate from each other and surrounding said central space and foodstuff, said cavities having depth, height and width sufficient to accommodate an amount of salt, said amount of salt being sufficient to generate thermal barrier around and above said central space and foodstuff.

5. The salt roasting means according to claim 1, wherein said cavities are of dimensions and number enabling them to operate in concert in generating said thermal barrier when accommodating sufficient amount of said salt.

6. The salt roasting means according to claim 2, wherein said geometric shape of said cooking vessel is selected from round, triangular, rectangular, pentagonal, hexagonal and octagonal shaped tray.

7. The salt roasting means according to claim 2, wherein said cooking vessel has of any depth for providing sufficient volume for containing the foodstuff.

8. The salt roasting means according to claim 1, wherein said foodstuff is suitable for salt roasting with said means is selected from chicken, fish, cattle meat, turkey, vegetables such as potatoes and onions and fruits.

9. The salt roasting means according to any one of claim 1-8, wherein said salt roasting means is made of heat conducting materials selected from metals, metallic alloys and ceramics.

10. The salt roasting means according to claim 9, wherein said metals, metallic alloys and ceramics are selected from galvanized iron, metallic alloys containing copper, nickel, chromium, molybdenum and carbon, aluminum, cast iron, carbon steel, stainless steel, austenitic stainless steel, enameled cast iron, enamel over steel, clad aluminum or copper, glazed ceramics and porcelain.

11. The salt roasting means according to claim 1, wherein said salt roasting means is made of tempered glass, borosilicate glass, glass-ceramic and baking stone.

12. The salt roasting means according t claim 1, further comprising non-stick coating selected from polytetrafluoroethylene (PTFE), anodized aluminium, ceramics, silicone, enameled cast iron, black stone or marble stone and seasoned cast iron.

13. The salt roasting means according to claim 1, further comprising marble stone or black stone.

14. The salt roasting means according to claim 13, wherein thickness of said marble stone or black stone is between 25 μm to 60 μm.

15. The salt roasting means according to claim 1, further comprising induction ferrous layer for induction cooking.

16. The salt roasting foodstuff according to claim 1, wherein said salt roasting means is cooking vessel, said peripheral location is a closed channel surrounding an inner perimeter around bottom surface of said cooking vessel, said closed channel is removably installed in said cooking vessel.

17. The salt roasting foodstuff according to claim 16, wherein said closed channel comprises a rail at bottom outer surface, said rail matching a recess engraved in said bottom surface of said cooking vessel.

18. The salt roasting foodstuff according claim 17, wherein said recess further comprises holes for securing said closed channel to said bottom surface of said cooking vessel with screws.

19. The salt roasting foodstuff according claim 2, wherein said cooking further comprises a cover, said cover is made of glass or Pyrex and comprises opening for introducing liquids during a smoking process onto said foodstuff.

20. The salt roasting means according to any one of claims 1-19, wherein said salt is sodium chloride salt selected from kosher salt, table salt and Atlantic sea salt.

21. The salt roasting means according to any one of claim 20, wherein said salt further comprises flavor enhancing additives for smoking the foodstuff.

22. The salt roasting means according to any one of claim 21, wherein said additives are selected from Hickory wood chips, herbs, e.g., Rosemary, and any combination thereof.

23. A Closed space heat generating means configured for accommodating salt roasting means and provide appropriate physical and thermal conditions for salt roasting foodstuff placed on a central space of salt roasting means with salt distributed on peripheral location or locations surrounding said central space and said foodstuff.

24. The closed space heat generating means according to claim 23, wherein said means is an oven configured to provide appropriate physical and thermal conditions for said salt to generate thermal barrier around and above said central space and foodstuff and enable salt roasting of said foodstuff.

25. The oven according to claim 24, selected from ceramic oven, brick oven, gas oven, electric oven, masonry oven and wall oven.

26. A method for salt roasting foodstuff comprising:
providing salt roasting means comprising central space configured for placing foodstuff and peripheral location or locations surrounding said central space for placing said foodstuff and configured for distributing salt around said foodstuff;
providing closed space heat generating means;
elevating temperature in said closed space heat generating means;
distributing batch of salt in said peripheral location or locations of said salt roasting means;
providing foodstuff and placing it on said central place of said salt roasting means;
placing said salt roasting means with said foodstuff and distributed salt in said closed space heat generating means;
roasting said foodstuff for a desired period of time;
taking said salt roasting means out of said closed space heat generating means;
removing said foodstuff that is roasted; and
removing said distributed salt.

27. The salt roasting method according to claim 26, further comprising:
removing disposable residues of said foodstuff after salt roasting from said salt roasting means;
cleaning said salt roasting means;
placing another foodstuff on said central space of said salt roasting means;
redistributing said batch of salt in said peripheral location or locations of said salt roasting means; and
reiterating said salt roasting method.

28. The method according to claim 23, wherein said closed space heat generating means is an oven configured to provide appropriate physical and thermal conditions for said salt to generate thermal barrier around and above said central space and foodstuff and enable salt roasting of said foodstuff.

29. The method according to claim 23, wherein said oven is selected from ceramic oven, brick oven, gas oven, electric oven, masonry oven and wall oven.

30. The method according to claim 23, wherein said salt roasting means is a cooking vessel.

31. The method according to claim 30, wherein geometric shape of said cooking vessel is selected from round, triangular, rectangular, pentagonal, hexagonal and octagonal shaped tray.

32. The salt roasting means according to claim 30, wherein said cooking vessel has of any depth for providing sufficient volume for containing the foodstuff.

33. The salt roasting means according to claim 23, wherein said foodstuff suitable for salt roasting with said means is selected from chicken, fish, cattle meat, turkey, vegetables such as potatoes and onions and fruits.

34. The method according to claim 23, wherein said salt is sodium chloride selected from kosher salt, table salt and Atlantic sea salt.
